(19) United States
(12) Patent Application Publication
(10) Pub. No.: US 2023/0337585 A1
(43) Pub. Date: Oct. 26, 2023

(54) AGRICULTURAL IMPLEMENT

(71) Applicant: Kverneland Group Kerteminde A/S, Kerteminde (DK)

(72) Inventors: Stefan GOHL, Gottmadingen (DE); Henning SALZER, Gottmadingen (DE)

(21) Appl. No.: 18/302,949

(22) Filed: Apr. 19, 2023

(30) Foreign Application Priority Data
Apr. 22, 2022 (EP) 22169386

(51) Int. Cl. A01D 78/10

(52) U.S. Cl. CPC A01D 78/1007; A01D 78/105

(57) ABSTRACT

An agricultural implement is described comprising a chassis, a rotor mounted thereon that is rotatable about an upright axis and comprises working tools, a hydraulic lifting device for raising the chassis between a work position and a transport position, and an adjustment mechanism for adjusting the height of the rotor for the work position. The lifting device is arranged underneath the rotor and is connected to a hydraulic line that is run from top to bottom through the rotor. The adjustment mechanism comprising a tubular actuating element surrounding the hydraulic line or forming sections thereof with at least one axial adjustment thread mutually supporting the rotor and the chassis and an operating device arranged above the rotor for axially turning the actuating element.

### CLAIM FOR PRIORITY

This application claims the benefit of priority of European Application Number 22169386.4, filed Apr. 22, 2022, which is hereby incorporated by reference in its entirety.

### BACKGROUND

A generic agricultural implement can include the form of a trailed gyro rake. It can comprise a front and a rear rotor comprising working tools, each configured as spring tines, where the rotors are able to be mounted on separate chassis. For example, the chassis of the rear rotor then has to be raised separately from a work position with the work tools being lowered to a transport position with the work tools being raised. Four-wheel chassis suitable for this purpose comprise front and rear wheels, where the rear ones in the transport position make contact with the ground and the front ones are then raised. Raising is preferably done with the aid of a rocker construction which is adjusted by a hydraulic cylinder. Since the hydraulic cylinder is disposed underneath the rotor associated with the chassis, the hydraulic cylinder is typically operated via a hydraulic line that runs from top to bottom through the axis of rotation of the rotor.

### SUMMARY/OVERVIEW

Since the height of the rotor in relation to the chassis is fixed in such implements, the work height of the rotor (height in the work position in relation to the ground being driven on) is set in the generic implement or rotary rake by adjusting the positions of the wheels on the chassis. To do this, firstly, the front and rear wheels of the chassis must be adjusted separately and, secondly, this is only possible when the load is taken off the chassis, in the transport position. In addition, the height adjustment must be performed manually with tools underneath the rotor.

The adjustment of the work height of the rotor has therefore been very complicated in practice in the past so that this is often done only for the initial operation of the machine. The reasons for this is, inter alia, that the height adjustment on the front and rear wheels influences each other, since the inclination of the implement is then also changed in the process. In practice, therefore, repeated adjustment steps are necessary, i.e. gradually adjusting the front and rear wheels in the transport position, lowering them to the work position, and verifying the setting obtained, while possibly repeatedly correcting the adjustment. This is non-ergonomic and dangerous due to the arrangement of the adjustment mechanism underneath the rotor.

There is therefore a need for agricultural implements that are improved in comparison, in particular gyro rakes, for performing the height adjustment of the rotor for the work position in a simpler, safer, and more ergonomic manner.

An agricultural implement can comprise a chassis, a rotor mounted thereon that is rotatable about an upright axis and comprises with working tools, and a hydraulic lifting device for raising the chassis between a work position and a transport position in which the rotor is raised further up with respect to the ground traveled on than in the work position. The lifting device is arranged underneath the rotor and is connected to a hydraulic line that is run from top to bottom through the rotor. In addition, the agricultural implement can further comprise an adjustment mechanism for adjusting the height of the rotor for the work position or, in other words, for adjusting the work height of the rotor.

According to the present disclosure, the adjustment mechanism can comprise a tubular actuating element surrounding the hydraulic line or forming sections thereof with at least one axial adjustment thread mutually supporting the rotor and the chassis as well as an operating device arranged above the rotor for axially turning the actuating element, in particular without tools. The actuating element can be turned by the operating device about the axis of rotation of the rotor, for example, by ways of a hand wheel, a crank, or a drive motor, for adjusting the height of the rotor by way of the adjustment thread in the work position with respect to the chassis carrying it.

The work height of the rotor can therefore be adjusted ergonomically on its upper side by way of the operating device. In addition, the height of the rotor is adjusted relative to the chassis as a whole so that the front and rear wheels of a four-wheel chassis no longer have to be adjusted separately. It is thereby possible to adjust the height of the rotor without changing its inclination at the same time. Repeated corrections are therefore typically no longer necessary when adjusting the height.

The hydraulic line is preferably formed to be rigid for the axially load-bearing connection or mutual support of the rotor and the chassis. This enables a compact design.

The tubular actuating element enables, for example, height adjustment of 30 to 150 mm.

For example, type M22×1.5 and/or M16×1.5 is suitable as an adjustment thread. A combination of different thread pitches and/or a combination of right-hand and left-hand threads is also possible.

The tubular actuating element is preferably a threaded bushing surrounding the hydraulic line and having an internal thread (first adjustment thread) which interacts with an external thread formed at the hydraulic line. By turning the threaded bushing, an axial stroke of the hydraulic line can be effected as a function of the thread pitch without co-rotating it with the threaded bushing. This enables a structurally simple connection of the hydraulic line above and below the rotor and adjustability under load.

The threaded bushing preferably also comprises an external thread in the opposite direction (second adjustment thread) which interacts in a supporting manner with an internal thread which is arranged in a rotationally fixed manner on a rotor axis or a housing that is formed for mounting the rotor. This means that the internal thread and the external thread of the threaded bushing are formed to be in opposite directions to one another. By turning the threaded bushing, a first relative stroke can be caused between the former and the hydraulic line and at the same time a second relative stroke between the threaded bushing and the rotor axis (the housing) for mounting the rotor. The hydraulic line does not turn when the height of the rotor is adjusted with the threaded bushing.

The partial strokes caused by the thread pitches of the internal and external threads of the threaded bushing when it is turned add up to a total stroke of the height adjustment, which enables a compact design and quick height adjustment.

In a further advantageous embodiment, the threaded bushing is mounted on its outer side to be rotatable at a fixed height to a rotor axis or a housing that is/are furthermore formed for mounting the rotor. In this case, not only the threaded bushing, but also the operating device associated therewith, remains in a vertical position this is fixed with respect to the rotor. The operating device can then be arranged in a relative simple manner in the region of the rotor, for example, on the so-called rotor head. This also favors a motorized drive of the operating device.

The hydraulic line as a whole is preferably attached in a manner not co-rotating with the actuating element. This facilitates the hydraulic connection on both sides to static pressure hoses or the like.

In a further advantageous embodiment, the actuating element is configured in the form of a hollow spindle (rigid tubular spindle with an external thread) as a component of the hydraulic line, where the latter then comprises hydraulic rotary feedthroughs at its ends. Unlike the embodiments described above, the rigid hydraulic line then necessarily co-rotates when the height of the rotor is adjusted. Accordingly, hydraulic rotary feedthroughs allow for a non-co-rotating connection of the hydraulic line on the upper side and the underside of the rotor to pressure hose lines or similar lines, for example, to the hydraulic lifting device. The supporting actuating element and the hydraulic line can therefore be provided in a comparatively simple and space-saving manner in the form of the hollow spindle.

The operating device preferably comprises a bevel gear or worm gear connected to the actuating element. This enables comparatively simple manual height adjustment using a hand crank or a motor drive.

The operating device preferably comprises an electric drive motor. It enables flexible and quick height adjustment of the rotor, for example, in different work situations, and makes manual adjustment of the work height obsolete. In addition, setting previously stored work heights is possible by way of an associated electronic control unit.

In a further advantageous embodiment, the operating device comprises a hand wheel affixed coaxially on the actuating element. It is comparatively compact and can advantageously be permanently attached to the rotor head.

The adjustment mechanism for height adjustment/setting the work height is preferably configured under a dead load of the rotor acting in the work position. It is then no longer necessary to take the load off or lift the chassis to adjust the height of the rotor. Adjusted work heights can then be verified easily and quickly. The height adjustment can be displayed above the rotor by way of a scale, which can be read from a distance, for example, from an associated tractor and therefore by its driver.

The chassis preferably comprises front and rear wheels, i.e. it is then configured as a four-wheel chassis, where the rear wheels have contact with the ground in the transport position and the front wheels are raised in the process. This makes it possible to provide an effective lifting device that interacts particularly advantageously with the adjustment mechanism described.

The chassis preferably comprises a rocker with wheels mounted thereon, where the lifting device comprises at least one hydraulic cylinder for pivoting the rocker. This also serves as a lifting device that can be combined particularly well with the adjustment mechanism according to the present disclosure.

The agricultural implement is preferably a trailed gyro rake. The latter then preferably comprises a front and a rear rotor, where the chassis described and the adjustment mechanism are associated separately with the rear rotor. Since the adjustment mechanism at the rear rotor is relatively far away from an associated tractor, it interacts particularly advantageously with the lifting device. However, the agricultural implement according to at least one of the embodiments described could also be, for example, a trailed gyro redder.

### BRIEF DESCRIPTION OF THE FIGURES

Preferred embodiments of the invention shall be illustrated by way of drawings, where:

FIGS. 1A and 1B show a side view of the agricultural implement in a work position and in a transport position;

FIGS. 2A to 2C show a first embodiment of the adjustment mechanism with the rotor and the chassis;

FIGS. 3A and 3B show a second embodiment of the adjustment mechanism with the rotor and the chassis; and

FIGS. 4A to 4C show a third embodiment of the adjustment mechanism with the rotor and the chassis.

### DETAILED DESCRIPTION

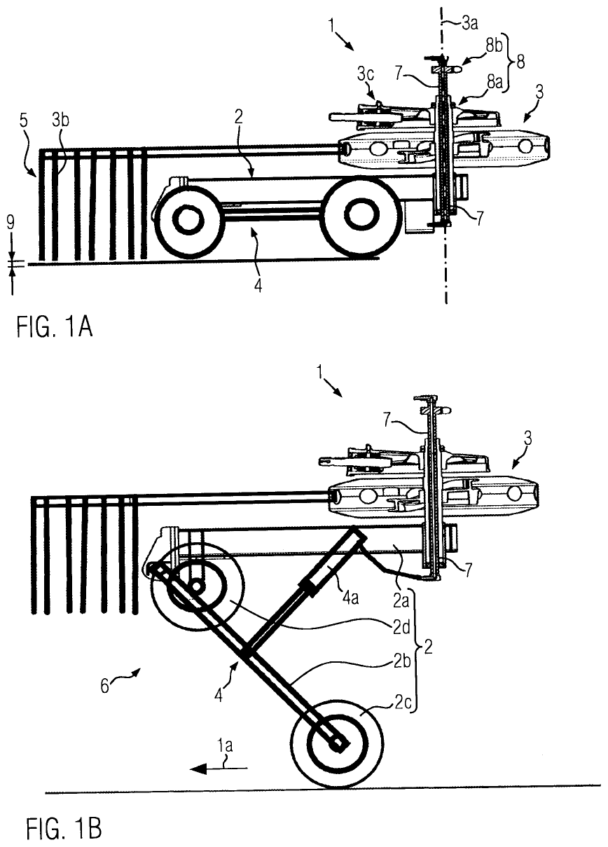

As can be seen in FIGS. 1A and 1B, agricultural implement 1, which is a trailed gyro rake in the example, comprises a chassis 2, a rotor 3 mounted thereon that is rotatable about an upright axis 3a and comprises working tools 3b which can be, for example, spring tines, and a hydraulic lifting device 4 for raising chassis 2 between a work position 5 shown by way of example in FIG. 1A and a transport position 6 shown by way of example in FIG. 1B. Rotor 3 is in particular the rear rotor of a dual gyro rake.

A drive 3c for rotor 3 arranged above rotor 3 in a gear head is furthermore visible. Direction of travel 1a (behind a tractor, not shown) is indicated schematically by an arrow in FIG. 1B.

Lifting device 4 is arranged beneath rotor 3 and is connected to a tubular hydraulic line 7 that is run from top to bottom through rotor 3, for example, by way of a pressure hose line.

Implement 1 furthermore comprises an adjustment mechanism 8 for adjusting the height of rotor 3 in work position 5 with respect to chassis 2. For this purpose, adjustment mechanism 8 comprises, firstly, a tubular actuating element 8a surrounding hydraulic line 7 or forming sections thereof and an operating device 8b arranged above rotor 3 for turning actuating element 8a about axis 3a. A work height 9 that is effective in work position 5 of rotor 3 can thus be set by linearly raising or lowering the latter with respect to the overall completely lowered chassis 2.

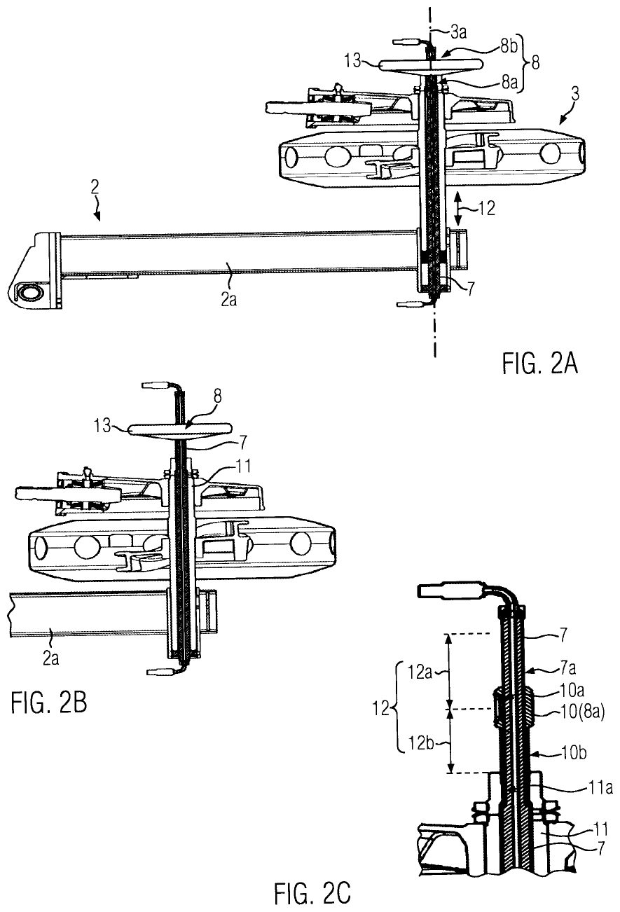

As can be seen in FIGS. 2A to 2C for a first preferred embodiment of adjustment mechanism 8, tubular actuating element 8a can be configured as a threaded bushing 10 surrounding hydraulic line 7 and having an internal thread (first adjustment thread) 10a which interacts with an external thread 7a formed at rigid hydraulic line 7. An M16×1.5_L thread, for example, is suitable for this.

Furthermore, threaded bushing 10 can comprise an external thread (second adjustment thread) 10b which interacts with an internal thread 11a formed on a rotor axis 11, a gear housing, or similar fixed structure for mounting rotor 3. An M22×1,5_R thread, for example, is suitable for this.

Chassis 2 and rotor 3 then mutually support each other via hydraulic line 7, threaded bushing 10, and non-co-rotating rotor axis 11, or a similar support structure.

Internal thread 10a and external thread 10b of threaded bushing 10 are formed in opposite directions for example a right-hand thread on the outside and a left-hand thread on the inside or vice versa). Turning threaded bushing 10 then simultaneously causes a first partial stroke 12a between hydraulic line 7 and threaded bushing 10 and a second partial stroke 12b between threaded bushing 10 and rotor axis 11. Partial strokes 12a, 12b therefore add up to an adjustment stroke 12 between, firstly, rotor axis 11 with rotor 3 affixed vertically thereon and, secondly, frame 2 with hydraulic line 7 fixed vertically relative thereto.

Hydraulic line 7 then does not co-rotate overall during the height adjustment so that pressure hoses or similar lines that are run on implement 1 can be directly connected in an uncomplicated manner.

Adjustment stroke 12 is, for example, 30 to 150 mm. This can be achieved by combining partial strokes 12a, 12b in a compact design.

In FIG. 2A, rotor 3 is illustrated in its uppermost position with respect to chassis 2 and therefore at maximum work height 9, in FIG. 2B in its lowermost position and therefore at minimum work height 9.

FIGS. 2A and 2B show that operating device 8b can comprise a hand wheel 13 which is attached coaxially with axis 3a to tubular actuating element 8a/threaded bushing 10. The hand wheel 13 is omitted in FIG. 2C for the sake of clarity.

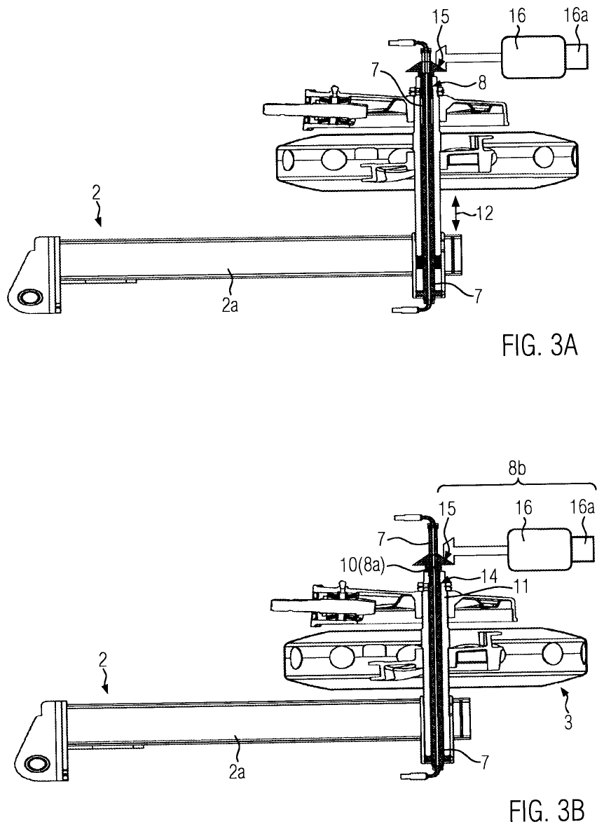

FIGS. 3A and 3B show a second preferred embodiment of adjustment mechanism 8 which differs from the embodiment described above substantially in that threaded bushing 10 and rotor axis 11 do not support each other by way of threads, but by way of a vertically (axially) affixed bearing 14. Threaded bushing 10 then has no external thread (second adjustment thread) 10b.

Work height 9 of rotor 3 with respect to hydraulic line 7 and chassis 2 is then accordingly adjusted only by way of internal thread (first adjustment thread) 10a of threaded bushing 10 and of external thread 7a of rigid hydraulic line 7, which, however, then likewise does not co-rotate.

Accordingly, adjustment stroke 12 in this embodiment is identical to previously described first partial stroke 12a.

As can also be seen schematically in FIGS. 3A and 3B, operating device 8b can comprise a bevel gear 15 and/or a drive motor 16 for operating adjustment mechanism 8 by motor and possibly in an automated manner. However, this combination is only to be understood to be an example. In this way, drive motor 16 could also be connected to tubular actuating element 8a by way of a different type of gear. Bevel gear 15 could also be driven manually using a hand crank or the like.

Preferably associated with drive motor 16 is an electronic control unit 16a with which different work heights 9 can be approached in a selective and reproducible manner, for example, as a result of programming. Operation would then also be possible, for example, by radio from a tractor. It goes without saying that control unit 16a does not need to be arranged in the vicinity of drive motor 16.

One advantage of the second embodiment of adjustment mechanism 8 is that operating device 8b, for example, bevel gear 15 and drive motor 16, can be arranged at a fixed height relative to rotor 3 and rotor axis 11 or a similar support structure for rotor 3 due to a lacking second partial stroke 12b. This can be particularly advantageous when adjustment mechanism 8 is driven by a motor.

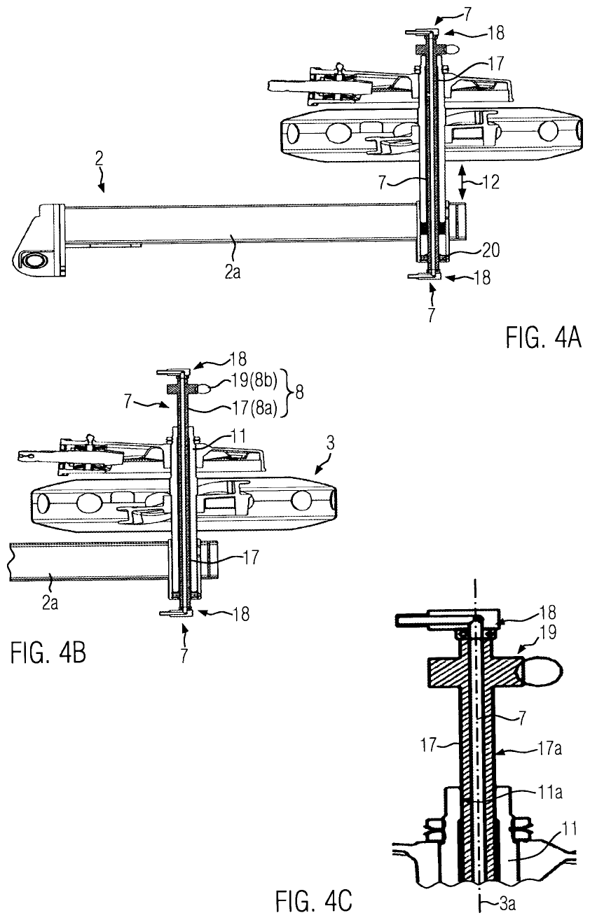

FIGS. 4A to 4C show a third preferred embodiment of adjustment mechanism 8 which differs from the embodiments previously described substantially in that tubular actuating element 8a is configured as a hollow spindle 17 forming a supporting section of hydraulic line 7 and in the height adjustment of rotor 3 described co-rotates about axis 3a.

Rigid hollow spindle 17 comprises an external thread (third adjustment thread as an alternative to the first and, possibly, second adjustment thread) 17a, which interacts during height adjustment in the manner described above with an internal thread 11a formed at non-co-rotating rotor axis 11 or similar support structure. Accordingly, adjustment stroke 12 in this embodiment is identical to previously described second partial stroke 12b.

In this embodiment, hydraulic line 7 comprises rotary feedthroughs 18 at the upper and lower end of rigid hollow spindle 17 which each produce a pressure-tight connection to pressure hoses or similar lines that do not co-rotate during the height adjustment. As indicated in FIG. 4A, hollow spindle 17 is supported towards the bottom by an axial bearing 20 on carrier 2a.

Operating device 8b can comprise, for example, a worm gear 19 which is indicated only schematically and by way of example in FIGS. 4A to 4C. It could be driven, for example, using a hand crank (not shown) or by a motor.

It goes without saying that the embodiments of operating device 8b described can be combined with all of the embodiments of tubular actuating element 8a described. The decisive factor there is that operating device 8b be arranged respectively above rotor 3 and therefore be easily and ergonomically accessible for an operator or allow for a simple motorized drive. In all of the embodiments, tubular actuating element 8a additionally causes linear height adjustment of rotor 3 with respect to chassis 2 without changing the rotor inclination so that step-by-step verification and correction of the height adjustment performed are unnecessary.

In addition, adjustment threads 10a and possibly 10b, on the one hand, or 17a, on the other hand, depending on the embodiment each allow for adjustment of work height 9 when chassis 2 has been lowered to work position 5 and is therefore under the dead load caused by rotor 3. Chassis 2 therefore no longer has to be raised and the load taken off for adjusting work height 9. Adjustments made to work height 9 by way of adjustment mechanism 8 can instead be verified immediately in work position 5 and corrected if necessary.

As can be seen in particular in FIG. 1B, agricultural implement 1 is, for example, a gyro rake, where rotor 3 is associated with a separate chassis 2 which comprises a carrier 2a for mounting rotor 3 on chassis 2 and a rocker 2b that is pivotable relative thereto with rear wheels 2c mounted thereon. These front wheels 2d, which are associated in the sense of a four-wheel chassis, however, are preferably mounted at a fixed height relative to carrier 2a.

Chassis 2 comprises lifting device 4 with at least one hydraulic cylinder 4a which is coupled to rocker 2b for positioning the latter with respect to carrier 2a. When rocker 2b is strutted away, carrier 2a is raised with front wheels 2d and rotor 3 to transport position 6, where rear wheels 2c make permanent contact with the ground. Such lifting devices 4 are tried and tested and can be easily combined with adjustment mechanism 8 according to the present disclosure.

Such a combination of adjustment mechanism 8 and lifting device 4 on a possibly rear rotor 3 and chassis 2 of a trailed gyro rake with at least one rotor 3 is particularly advantageous. In this case, a rotor 3 that is comparatively far away from an associated tractor (not shown) can, firstly, be placed in transport position 6 in a tried and tested manner using lifting device 4 and, secondly, its working height 9 in lowered work position 5 can be adjusted easily and ergonomically.

As an alternative to the gyro rake described, adjustment mechanism 8 described could also be used on other agricultural implements with respective implements rotating about substantially upright axes and a hydraulic line that is coaxial in this respect, for example, on a gyro tedder. It can have features described, for example, in EP 0 627 878 A1, DE 29 30 152 A1 and/or DE 196 19 172 A1.

What is claimed is:

1. An agricultural implement comprising:
a chassis;
a rotor mounted on the chassis that is rotatable about an upright axis and comprises one or more working tools;
a hydraulic lifting device for lifting the chassis between a work position and a transport position, where the hydraulic lifting device is arranged underneath the rotor and connected to a hydraulic line that is run from top to bottom through the rotor; and
an adjustment mechanism for adjusting a height of the rotor for the work position, wherein the adjustment mechanism comprises:
a tubular actuating element surrounding the hydraulic line or forming sections thereof with at least one axial adjustment thread mutually supporting the rotor and the chassis; and
an operating device arranged above the rotor for turning the tubular actuating element axially.

2. The agricultural implement according to claim 1, wherein the hydraulic line is formed for mutual axial support of the rotor and the chassis.

3. The agricultural implement according to claim 1, wherein the tubular actuating element includes a threaded bushing surrounding the hydraulic line with an internal thread that interacts with an external thread formed at the hydraulic line.

4. The agricultural implement according to claim 3, wherein the threaded bushing further comprises an external thread in an opposite direction that interacts with an internal thread, and wherein the internal thread is arranged in a rotationally fixed manner at a rotor axis or a housing that is formed for mounting the rotor.

5. The agricultural implement according to claim 3, wherein the threaded bushing is mounted on an outer side so as to be rotatable at a fixed height on a rotor axis or a housing that is formed for mounting the rotor.

6. The agricultural implement according to claim 1, wherein the hydraulic line is arranged so as to not co-rotate with said tubular actuating element.

7. The agricultural implement according to claim 1, wherein the tubular actuating element is configured in the form of a hollow spindle as a component of the hydraulic line, and wherein the hydraulic line comprises a first hydraulic rotary feedthrough at a first end and a second hydraulic rotary feedthrough at a second end.

8. The agricultural implement according to claim 1, wherein the operating device comprises a bevel gear or worm gear connected to the tubular actuating element.

9. The agricultural implement according to claim 1, wherein the operating device comprises an electric drive motor.

10. The agricultural implement according to claim 1, wherein the operating device comprises a hand wheel affixed coaxially to the tubular actuating element.

11. The agricultural implement according to claim 1, wherein the adjustment mechanism is configured under a dead load of the rotor acting in the work position.

12. The agricultural implement according to claim 1, wherein the chassis comprises one or more front wheels and one or more rear wheels, and wherein the one or more rear wheels in the transport position make contact with the ground and the one or more front wheels are raised.

13. The agricultural implement according to claim 1, wherein the chassis comprises a rocker with one or more wheels mounted thereon, and wherein the hydraulic lifting device comprises at least one hydraulic cylinder for pivoting the rocker.

14. The agricultural implement according to claim 1, wherein the agricultural implement is a trailed gyro rake.

15. The agricultural implement according to claim 14, wherein the trailed gyro rake comprises a front rotor and a rear rotor, and wherein the chassis and the adjustment mechanism are associated separately with the rear rotor.
